(19) United States
(12) Patent Application Publication
(10) Pub. No.: US 2024/0305155 A1
(43) Pub. Date: Sep. 12, 2024

(54) MOTOR, COMPRESSOR, AND REFRIGERATION CYCLE APPARATUS

(71) Applicant: Mitsubishi Electric Corporation, Tokyo (JP)

(72) Inventors: Emi TSUKAMOTO, Tokyo (JP); Masahiro NIGO, Tokyo (JP)

(21) Appl. No.: 18/258,433

(22) PCT Filed: Feb. 24, 2021
(86) PCT No.: PCT/JP2021/006780

§ 371 Date: Jun. 20, 2023

(51) Int. Cl. H02K 3/34; H02K 1/16; H02K 3/30

(52) U.S. Cl. CPC H02K 3/345; H02K 1/16; H02K 3/30; H02K 2213/03

(57) ABSTRACT

A motor includes: a rotor including a rotor core having an annular shape about an axis, and permanent magnets attached to the rotor core; and a stator including a stator core having a core back surrounding the rotor from outside in a radial direction about the axis, teeth extending toward the rotor from the core back, and slots adjacent to the teeth in a circumferential direction about the axis, insulating portions fixed to the teeth, and windings, each being wound around the tooth via the insulating portion and having a conductive body made of aluminum. A radius Dr of the rotor core, a radius Ds of the stator core, and an area S of the slot satisfy: 25 mm≤Dr≤30 mm, 0.47≤Dr/Ds≤0.56, and 0.089≤S/Dr²≤0.224.

### CROSS-REFERENCE TO RELATED APPLICATION

This application is a U.S. National Stage Application of International Application No. PCT/JP2021/006780 filed on Feb. 24, 2021, the contents of which are incorporated herein by reference.

### TECHNICAL FIELD

The present disclosure relates to a motor, a compressor, and a refrigeration cycle apparatus.

### BACKGROUND

A motor includes a rotor having permanent magnets and an annular stator surrounding the rotor. The stator has a plurality of slots, in each of which a winding is housed (see, for example, Patent Reference 1). There are increasing cases where an aluminum wire is used as the winding instead of a conventional copper wire.

### PATENT REFERENCE

Patent Reference 1: International Publication No. WO2020/044420 (see, for example, FIG. 2)

Here, magnetic flux emitted from the permanent magnet of the rotor flows to surround the slot of the stator and then returns to the rotor. That is, a magnetic path is formed to surround the slot. In conventional motors, the area of the slot is relatively large, and the length of the magnetic path is long. Thus, the iron loss tends to increase.

On the other hand, if the slot area is made smaller, heat generated in the winding accumulates in the slot, and thus the temperature of the winding increases. An aluminum wire has higher electrical resistance and is more likely to generate heat than a copper wire. When the temperature of the winding rises, its electrical resistance also increases. This causes an increase in the copper loss, which leads to a reduction in motor efficiency.

### SUMMARY

The present disclosure is made to solve the above problem, and an object of the present disclosure is to suppress the reduction in the motor efficiency.

A motor of the present disclosure includes a rotor including a rotor core having an annular shape about an axis, and a permanent magnet attached to the rotor core, and a stator including a stator core having a core back surrounding the rotor from outside in a radial direction about the axis, a tooth extending toward the rotor from the core back, and a slot adjacent to the tooth in a circumferential direction about the axis, an insulating portion attached to the tooth, and a winding wound around the tooth via the insulating portion and having a conductive body made of aluminum. A radius Dr of the rotor core, a radius Ds of the stator core, and an area S of the slot satisfy 25 mm≤Dr≤30 mm, 0.47≤Dr/Ds≤0.56, and 0.089≤S/Dr²≤0.224.

According to the present disclosure, the iron loss and copper loss can be reduced, and thus a reduction in the motor efficiency can be suppressed.

### BRIEF DESCRIPTION OF THE DRAWINGS

FIG. 1 is a cross-sectional view illustrating a motor of a first embodiment.

FIG. 2 is a cross-sectional view illustrating a part of a stator of the first embodiment.

FIG. 3 is a cross-sectional view illustrating a tooth, an insulating portion, and a winding of the first embodiment.

FIG. 4 is a schematic diagram illustrating a cross-sectional structure of the winding of the first embodiment.

FIG. 5(A) is a cross-sectional view illustrating a motor of Comparative Example 1, and FIG. 5(B) is a cross-sectional view illustrating a part of a stator of Comparative Example 1.

FIG. 6(A) is a cross-sectional view illustrating a motor of Comparative Example 2, and FIG. 6(B) is a cross-sectional view illustrating a part of a stator of Comparative Example 2.

FIG. 7(A) is a cross-sectional view illustrating a motor of Comparative Example 3, and FIG. 7(B) is a cross-sectional view illustrating a part of a stator of Comparative Example 3.

FIG. 8(A) is a cross-sectional view illustrating a motor of Comparative Example 4, and FIG. 8(B) is a cross-sectional view illustrating a part of a stator of Comparative Example 4.

FIG. 9 is a graph showing the relationship between the ratio Dr/Ds of the radius of a rotor core to the radius of a stator core, and the iron loss.

FIG. 10 is a graph showing the relationship between the ratio S/Dr² of the slot area S to the square of the radius of the rotor core, and the iron loss.

FIG. 11 is a cross-sectional view illustrating a motor of a second embodiment.

FIG. 12(A) is a cross-sectional view illustrating a part of a stator of the second embodiment, and FIG. 12(B) is a cross-sectional view illustrating a tooth, insulating portions, and a winding of the second embodiment.

FIG. 13 is a schematic diagram illustrating a tooth, an insulator, and insulating films in one configuration example of the second embodiment.

FIG. 14(A) is a cross-sectional view illustrating a part of a stator of Comparative Example, and FIG. 14(B) is a cross-sectional view illustrating a tooth, insulating portions, and a winding of Comparative Example.

FIG. 15 is a cross-sectional view illustrating a motor of a third embodiment.

FIG. 16 is a cross-sectional view illustrating a motor of a modification.

FIG. 17 is a longitudinal-sectional view illustrating a compressor to which the motor of each embodiment and modification is applicable.

FIG. 18 is a diagram illustrating a refrigeration cycle apparatus to which the compressor of FIG. 17 is applicable.

### DETAILED DESCRIPTION

### First Embodiment

### (Configuration of Motor)

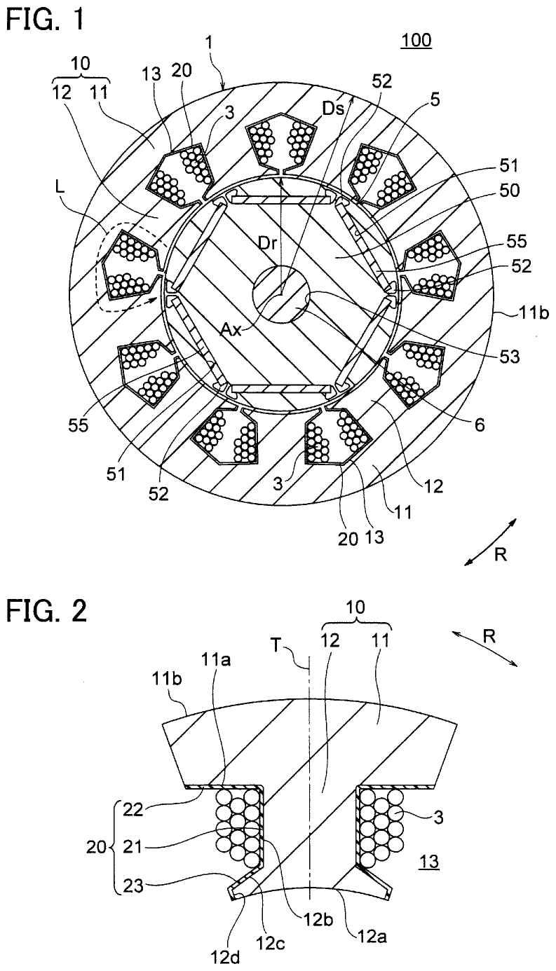

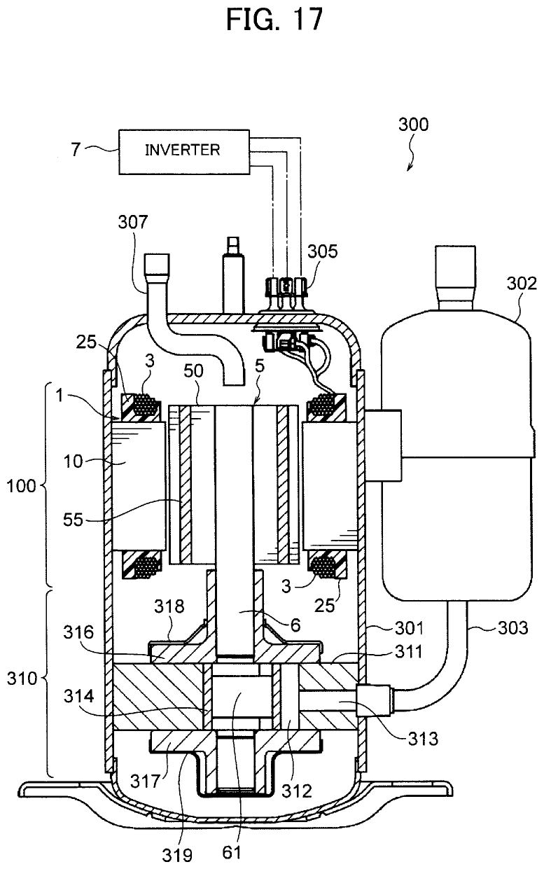

FIG. 1 is a cross-sectional view illustrating a motor 100 of a first embodiment. The motor 100 illustrated in FIG. 1 is a 3-phase synchronous motor. The motor 100 is used in, for example, a compressor 300 (FIG. 17), and is driven and controlled by an inverter 7.

The motor 100 has a rotor 5 having a shaft 6, which is a rotation shaft, and a stator 1 provided to surround the rotor 5. An air gap of, for example, 0.3 to 1.0 mm is formed between the stator 1 and the rotor 5. The stator 1 is incorporated inside a hermetic container 301 of the compressor 300 ((FIG. 17) to be mentioned later.

Hereinafter, the direction of an axis Ax, which is a rotation axis of the rotor 5, i.e., the center axis of the shaft 6, is referred to as an “axial direction”. The radial direction about the axis Ax is referred to as a “radial direction”. The circumferential direction about the axis Ax is referred to as a “circumferential direction”, and indicated by an arrow R in FIG. 1 and other figures.

### (Configuration of Rotor)

The rotor 5 has a rotor core 50 having a cylindrical shape about the axis Ax and permanent magnets 55 attached to the rotor core 50. The rotor core 50 is formed of a plurality of electromagnetic steel sheets which are stacked in the axial direction and fixed together by crimping or the like.

Each electromagnetic steel sheet has a sheet thickness of 0.1 to 0.7 mm, and is 0.35 mm in this example. The rotor core 50 has a center hole 53 formed at its center in the radial direction. The shaft 6 is fixed to the center hole 53 of the rotor core 50 by shrink-fitting or press-fitting. The rotor core 50 has a circular outer circumference.

The rotor core 50 has a radius Dr. The radius Dr is a distance from the axis Ax to the outer circumference of the rotor core 50. The radius Dr of the rotor core 50 is 25 to 30 mm, and is 29.25 mm as an example.

A plurality of magnet insertion holes 51 in which the permanent magnets 55 are inserted are formed along the outer circumference of the rotor core 50. Each magnet insertion hole 51 corresponds to one magnetic pole, and an inter-pole portion is defined between adjacent magnet insertion holes 51. The number of magnet insertion holes 51 is six in this example. In other words, the number of poles is six. However, the number of poles is not limited to six, but only needs to be two or more.

Each magnet insertion hole 51 extends linearly in a direction perpendicular to a straight line in the radial direction which passes through the center of the magnet insertion hole 51 in the circumferential direction, i.e., the pole center. One permanent magnet 55 is inserted in each magnet insertion hole 51.

Incidentally, two or more permanent magnets 55 may be arranged in each magnet insertion hole 51. The magnet insertion hole 51 is not limited to the linear shape, but may extend in a V-shape, for example.

The permanent magnet 55 is a flat-plate shaped member that has a width in the circumferential direction of the rotor core 50 and a thickness in the radial direction of the rotor core 50. The permanent magnet 55 is composed of a rare earth magnet that contains, for example, neodymium (Nd), iron (Fe), and boron (B).

The rare earth magnet has properties such that its coercive force decreases with increasing temperature, and the rate of the decrease is −0.5 to −0.6%/K. The rare earth magnet is required to have a coercive force of 1100 to 1500 A/m in order to prevent demagnetization of the rare earth magnet at the occurrence of the maximum load expected in a compressor. In order to secure this coercive force under an ambient temperature of 150° C., the rare earth magnet needs to have a coercive force of 1800 to 2300 A/m at normal temperature, i.e., 20° C.

Thus, dysprosium (Dy) may be added to the rare earth magnet. The coercive force of the rare earth magnet at normal temperature is 1800 A/m without addition of Dy and is 2300 A/m by adding 2 wt % of Dy. However, the addition of Dy causes an increase in the manufacturing cost and a decrease in the residual magnetic flux density. For this reason, it is desirable to add as little Dy as possible or not to add Dy.

In the rotor core 50, a flux barrier 52, which serves as a leakage magnetic flux suppression hole, is formed at each of both ends of the magnet insertion hole 51 in the circumferential direction. A thin-walled portion is formed between the flux barrier 52 and the outer circumference of the rotor core 50. The width of the thin-walled portion is set to be the same as the sheet thickness of the electromagnetic steel sheet of the rotor core 50 in order to suppress short circuit of the magnetic flux between adjacent magnetic poles.

### (Configuration of Stator)

The stator 1 has a stator core 10 surrounding the rotor core 50 from outside in the radial direction and windings 3 wound on the stator core 10. The stator core 10 is formed of a plurality of electromagnetic steel sheets which are stacked in the axial direction and fixed together by crimping or the like. A sheet thickness of each electromagnetic steel sheet is 0.1 to 0.7 mm, and is desirably particularly 0.35 mm.

The stator core 10 has a core back 11 having an annular shape about the axis Ax, and a plurality of teeth 12 extending inward in the radial direction from the core back 11. The core back 11 has an inner circumference 11a (FIG. 2) and an outer circumference 11b.

The stator core 10 has a radius Ds. The radius Ds is a distance from the axis Ax to the outer circumference 11b of the core back 11. The radius Ds of the stator core 10 is, for example, 53.5 mm.

The teeth 12 are formed at constant intervals in the circumferential direction. The number of teeth 12 is nine in this example. However, the number of teeth 12 is not limited to nine, but only needs to be two or more. A slot 13, which is a space to house the winding 3, is formed between the teeth 12 adjacent to each other in the circumferential direction. The number of slots 13 is the same as the number of teeth 12, and is nine in this example.

The area of the slot 13 in a plane perpendicular to the axis Ax is simply referred to as the “area of the slot 13”. The total area of nine slots 13 in the stator core 10 is referred to as a “slot area S”. The slot area S in the stator core 10 of the first embodiment is, for example, 93.5 mm².

FIG. 2 is a cross-sectional view illustrating a part of the stator 1. The straight line in the radial direction that passes through the center of the tooth 12 in the circumferential direction is a tooth center line T. The tooth 12 has a tooth tip surface 12a at its inner end in the radial direction. The tooth tip surface 12a faces the rotor 5. A tip portion of the tooth 12, including the tooth tip surface 12a, protrudes on both sides of the tooth 12 in the circumferential direction relative to the other portion of the tooth 12.

The tooth 12 has side surfaces 12b at both ends thereof in the circumferential direction. The side surfaces 12b are parallel to the tooth center line T. An inclined surface 12c, which is inclined with respect to the tooth center line T, is formed on the inner side in the radial direction, i.e., on the rotor 5 side, of each side surface 12b of the tooth 12. An end surface 12d is formed between the inclined surface 12c and the tooth tip surface 12a.

The inner circumference 11a of the core back 11 extends linearly from a root portion of the side surface 12b of the tooth 12 at an angle of 90 degrees relative to the side surface 12b. Incidentally, the inner circumference 11a of the core back 11 may extend in an arc shape from the root portion of the side surface 12b of the tooth 12.

An insulating film 20 as an insulating portion is fixed to an inner surface of the slot 13 of the stator core 10. The insulating film 20 is made of a resin, such as polyethylene terephthalate (PET).

The insulating film 20 has a first portion 21 covering the side surface 12b of the tooth 12, a second portion 22 covering the inner circumference 11a of the core back 11, and a third portion 23 covering the inclined surface 12c and the end surface 12d of the tooth 12.

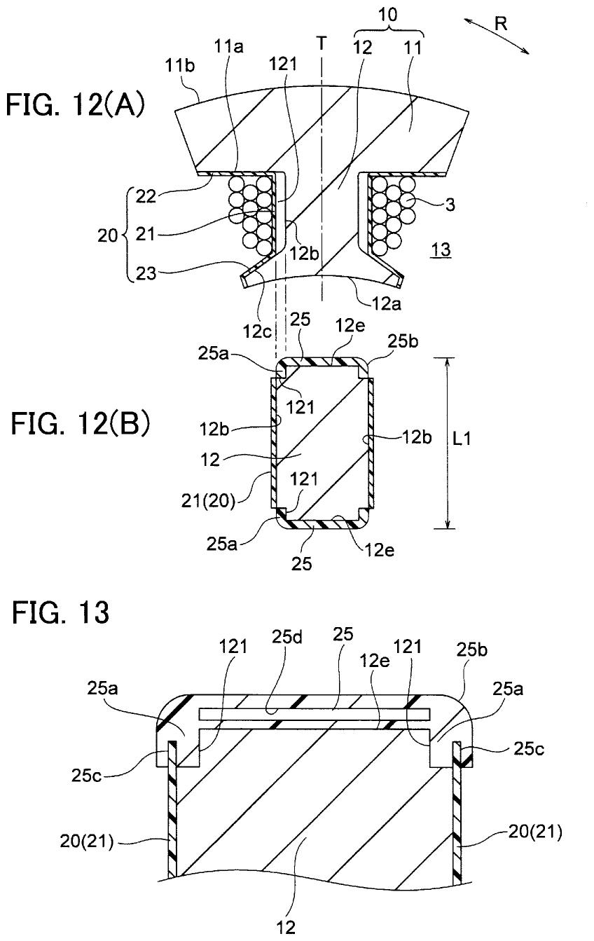

An insulator 25 (see FIG. 12(B)) as an insulating portion is provided at each end of the stator core 10 in the axial direction. The insulator 25 is made of, for example, a resin such as polybutylene terephthalate (PBT). The winding 3 is wound around the tooth 12 via the insulating films 20 and the insulators 25.

The winding 3 is formed of a magnet wire and wound around each tooth 12 in concentrated winding. The number of turns of the winding 3 on one tooth 12 is, for example, 80 turns. The windings 3 are connected in three-phase Y-connection. The wire diameter and the number of turns of the winding 3 are set according to the required characteristics of the motor 100, the applied voltage, and the area of the slot 13.

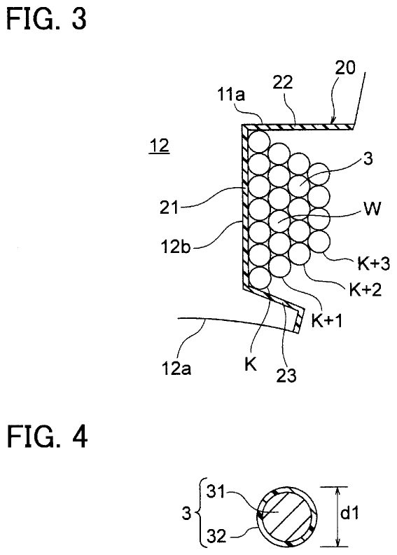

FIG. 3 is a cross-sectional view illustrating the tooth 12, the insulating film 20 and the winding 3. The winding 3 is wound on the side surface 12b of the tooth 12 in a bale stacked manner. The bale stacked manner refers to a manner in which the winding 3 is wound so that one winding portion (indicated by reference character W in FIG. 3) of the k+1 th layer (k≥1) of the winding 3 is in contact with two winding portions of the k-th layer of the winding 3.

The winding 3 is wound in the bale stacked manner, so that the occupancy ratio of the winding 3 in the slot 13 can be increased. The occupancy ratio is the ratio of the total cross-sectional area of the winding portions in the slot 13 to the area of the slot 13. By winding the winding 3 in the bale stacked manner, the contact area between the winding portions increases, and thus heat can be efficiently dissipated from the winding 3 to the stator core 10, and thus an increase in the temperature of the winding 3 can be suppressed.

In FIG. 3, the winding 3 is illustrated to have four layers for convenience of illustration, but the number of layers of the winding 3 is not limited. In addition, the winding 3 may be in contact with the second portion 22 and the third portion 23 of the insulating film 20, as well as the first portion 21.

FIG. 4 is a diagram illustrating a cross-sectional shape of the winding 3. The winding 3 has a conductive body 31 and a cover film 32 surrounding the conductive body 31. The conductive body 31 is made of aluminum. The cover film 32 is made of an insulating resin, for example, polyesterimide or polyamide-imide. A winding that includes the conductor made of aluminum as above is also referred to as an aluminum wire.

Since the thickness of the cover film 32 is thinner than the outer diameter of the conductive body 31, the outer diameter of the conductive body 31 can be regarded as an outer diameter d1 of the winding 3. The outer diameter d1 of the winding 3 is 0.7 to 1.2 mm.

### (Action)

Next, the action of the first embodiment will be described. Magnetic flux flowing from the rotor 5 into the stator core 10 flows through the periphery of the slot 13 as indicted by reference character L in FIG. 1 and returns to the rotor 5. Thus, a magnetic path is formed to surround the periphery of the slot 13 in the stator core 10. The iron loss caused in the stator 1 depends on the length of the magnetic path in the stator core 10. Thus, as the slot area S increases, the iron loss increases. As the slot area S decreases, the iron loss decreases.

As the cross-sectional area of the rotor 5 (Dr²×n) increases, the permanent magnets 55 mounted on the rotor 5 is made larger, and the magnetic flux flowing into the stator core 10 increases. For this reason, S/Dr² which is obtained by dividing the slot area S by the square of the radius Dr of the rotor core 50 is used as an index representing the susceptibility to iron loss in the stator 1.

Specific configuration examples 1 to 3 of the motor 100 of the first embodiment will be described hereinafter. The motors 100 of the configuration examples 1 to 3 of the first embodiment have the shape described with reference to FIG. 1, but they are different in the radius Dr of the rotor core 50 and the slot area S.

In the motor 100 of the configuration example 1 of the first embodiment, the radius Dr of the rotor core 50 is 29.25 mm, the radius Ds of the stator core 10 is 53.5 mm, and the slot area S is 93.5 mm². In this case, the ratio Dr/Ds of the radius of the rotor core 50 to the radius of the stator core 10 (hereinafter referred to simply as the radius ratio) is 0.55. The ratio S/Dr² of the slot area S to the square of the radius Dr of the rotor core 50 is 0.109.

In the motor 100 of the configuration example 2, the radius Dr of the rotor core 50 is 30.0 mm, the radius Ds of the stator core 10 is 53.5 mm, and the slot area S is 80.0 mm². In this case, the radius ratio Dr/Ds is 0.56, and the ratio S/Dr² of the slot area S to the square of the radius Dr is 0.089.

In the motor 100 of the configuration example 3, the radius Dr of the rotor core 50 is 25.0 mm, the radius Ds of the stator core 10 is 53.5 mm, and the slot area S is 140.0 mm². In this case, the radius ratio Dr/Ds is 0.47, and the ratio S/Dr² of the slot area S to the square of the radius Dr is 0.224.

Next, Comparative Examples 1 to 7, which are compared with the configuration examples 1 to 3 of the first embodiment, will be described.

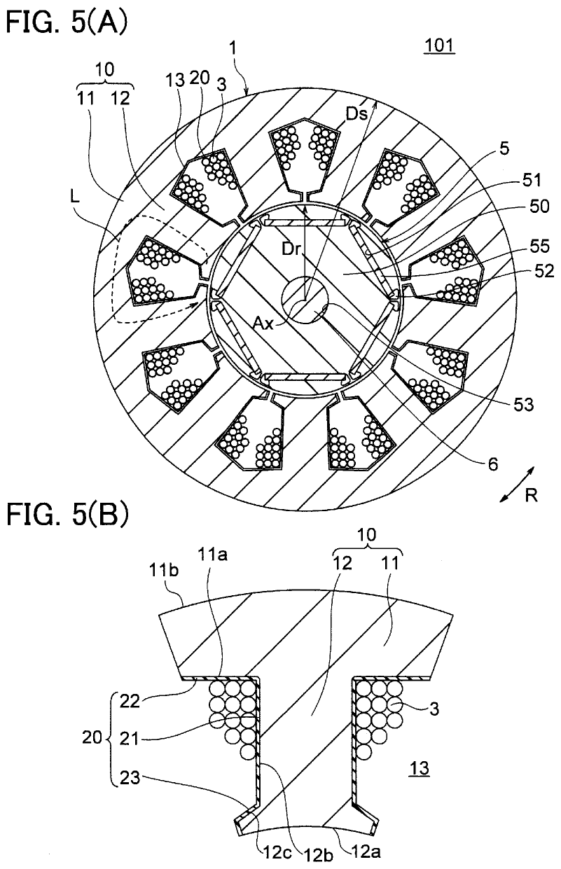

FIG. 5(A) is a cross-sectional view illustrating a motor 101 of Comparative Example 1. The motor 101 of Comparative Example 1 has six poles and nine slots. The radius Dr of a rotor core 50 is 24.0 mm, the radius Ds of a stator core 10 is 53.5 mm, and the slot area S is 132.0 mm². In this case, the radius ratio Dr/Ds is 0.45, and the ratio S/Dr² of the slot area S to the square of the radius Dr is 0.229.

FIG. 5(B) is a cross-sectional view illustrating a part of a stator 1 of the motor 101 of Comparative Example 1. An inner circumference 11a of a core back 11 of Comparative Example 1 extends linearly from a root portion of a side surface 12b of a tooth 12 at an angle of 90 degrees relative to the side surface 12b. The winding 3 is wound around the tooth 12 in the bale stacked manner, although the winding 3 is simplistically illustrated in FIG. 5(B).

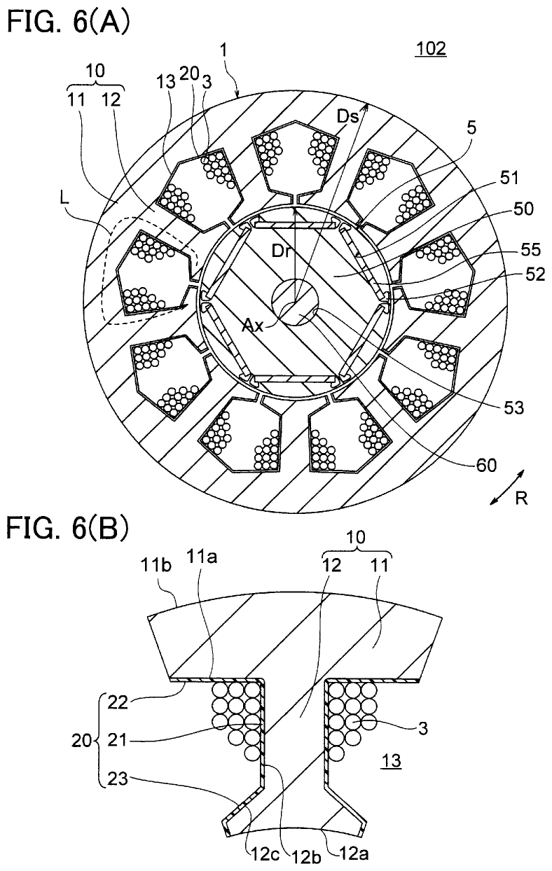

FIG. 6(A) is a cross-sectional view illustrating a motor 102 of Comparative Example 2. The motor 102 of Comparative Example 2 has six poles and nine slots. The radius Dr of a rotor core 50 is 24.0 mm, the radius Ds of a stator core 10 is 53.5 mm, and the slot area S is 144.6 mm². In this case, the radius ratio Dr/Ds is 0.45, and the ratio S/Dr² of the slot area S to the square of the radius Dr is 0.251.

FIG. 6(B) is a cross-sectional view illustrating a part of a stator 1 of the motor 102 of Comparative Example 2. An inner circumference 11a of a core back 11 of Comparative Example 2 extends linearly from a root portion of a side surface 12b of a tooth 12 at an angle of 90 degrees relative to the side surface 12b. The winding 3 is wound around the tooth 12 in the bale stacked manner, although the winding 3 is simplistically illustrated in FIG. 6(B).

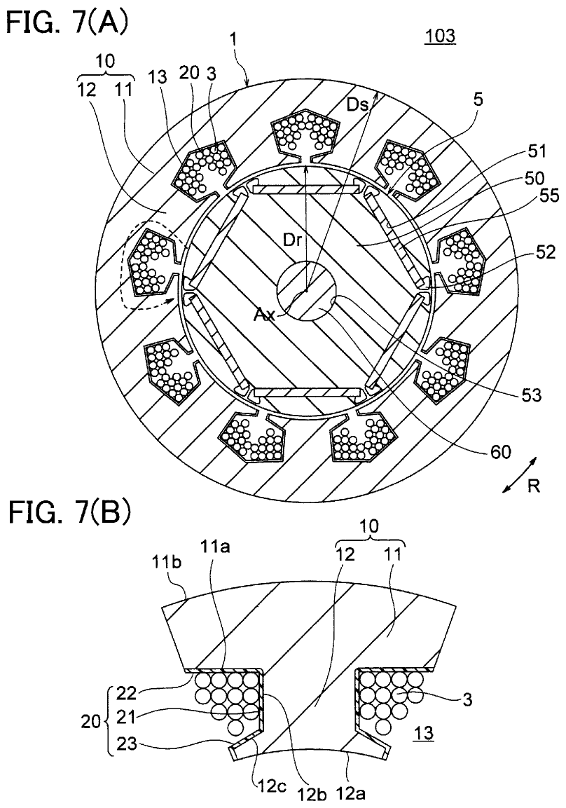

FIG. 7(A) is a cross-sectional view illustrating a motor 103 of Comparative Example 3. The motor 103 of Comparative Example 3 has six poles and nine slots. The radius Dr of a rotor core 50 is 32.0 mm, the radius Ds of a stator core 10 is 53.5 mm, and the slot area S is 79.2 mm². In this case, the radius ratio Dr/Ds is 0.60, and the ratio S/Dr² of the slot area S to the square of the radius Dr is 0.077.

FIG. 7(B) is a cross-sectional view illustrating a part of a stator 1 of the motor 103 of Comparative Example 3. An inner circumference 11a of a core back 11 of Comparative Example 3 extends linearly from a root portion of a side surface 12b of a tooth 12 at an angle of 90 degrees relative to the side surface 12b. The winding 3 is wound around the tooth 12 in the bale stacked manner, although the winding 3 is simplistically illustrated in FIG. 7(B).

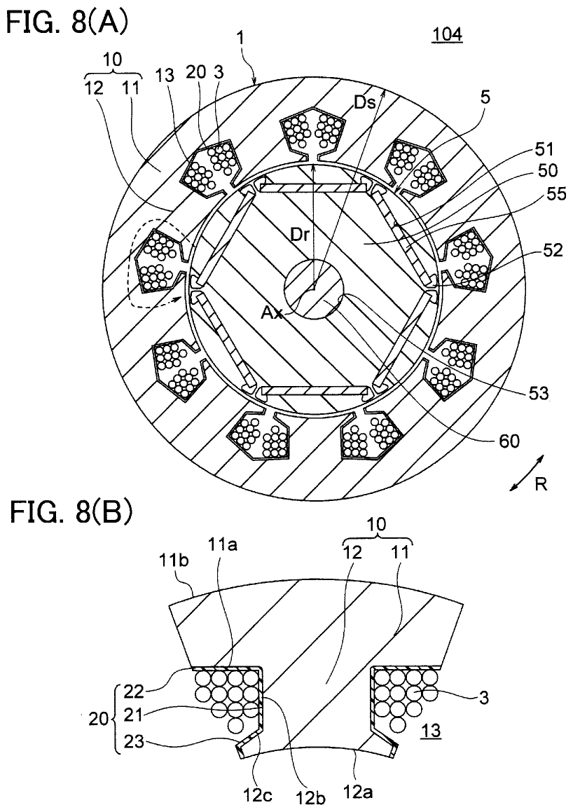

FIG. 8(A) is a cross-sectional view illustrating a motor 104 of Comparative Example 4. The motor 104 of Comparative Example 4 has six poles and nine slots. The radius Dr of a rotor core 50 is 32.0 mm, the radius Ds of a stator core 10 is 53.5 mm, and the slot area S is 69.9 mm². In this case, the radius ratio Dr/Ds is 0.60, and the ratio S/Dr² of the slot area S to the square of the radius Dr is 0.068.

FIG. 8(B) is a cross-sectional view illustrating a part of a stator 1 of the motor 104 of Comparative Example 4. An inner circumference 11a of a core back 11 of Comparative Example 4 extends linearly from a root portion of a side surface 12b of a tooth 12 at an angle of 90 degrees relative to the side surface 12b. The winding 3 is wound around the tooth 12 in the bale stacked manner, although the winding 3 is simplistically illustrated in FIG. 8(B).

A motor of Comparative Example 5 has the same shape as the motor 102 of Comparative Example 2 (FIG. 6(A)). In the motor of Comparative Example 5, the radius Dr of a rotor core 50 is 22.0 mm, the radius Ds of a stator core 10 is 53.5 mm, and the slot area S is 150.0 mm². The radius ratio Dr/Ds is 0.41, and the ratio S/Dr² of the slot area S to the square of the radius Dr is 0.310.

A motor of Comparative Example 6 has the same shape as the motor 102 of Comparative Example 2 (FIG. 6(A)). In the motor of Comparative Example 6, the radius Dr of a rotor core 50 is 20.0 mm, the radius Ds of a stator core 10 is 53.5 mm, and the slot area S is 154.0 mm². The radius ratio Dr/Ds is 0.37, and the ratio S/Dr² of the slot area S to the square of the radius Dr is 0.385.

A motor of Comparative Example 7 has the same shape as the motor 104 of Comparative Example 4 (FIG. 8(A)). In the motor of Comparative Example 7, the radius Dr of a rotor core 50 is 34.0 mm, the radius Ds of a stator core 10 is 53.5 mm, and the slot area S is 69.9 mm². The radius ratio Dr/Ds is 0.64, and the ratio S/Dr² of the slot area S to the square of the radius Dr is 0.060.

Next, measuring results of the iron loss of the motors of the configuration examples 1 to 3 of the first embodiment and Comparative Examples 1 to 7 will be described. The iron loss is measured by the Epstein test based on JIS C2550. The lengths of the motors in the axial direction in Configuration Examples 1 to 3 and Comparative Examples 1 to 7 are the same.

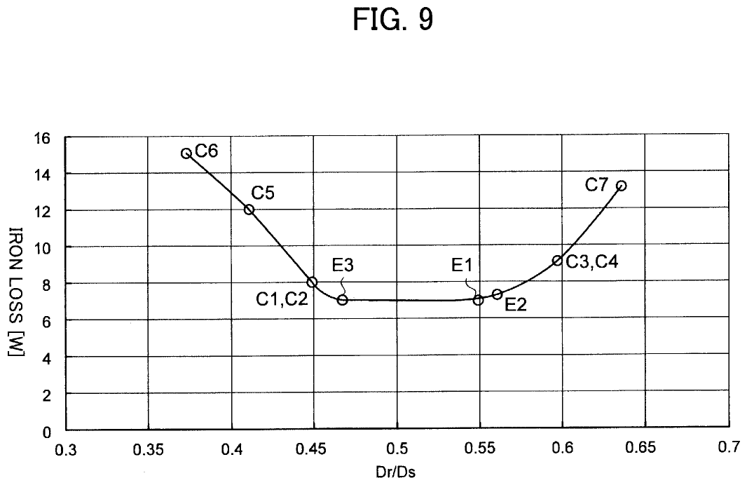

FIG. 9 is a graph showing the relationship between the radius ratio Dr/Ds between the rotor core 50 and the stator core 10, and the iron loss. The horizontal axis indicates the radius ratio Dr/Ds, while the vertical axis indicates the iron loss W. In FIG. 9, the data in the configuration examples 1 to 3 of the first embodiment are shown by points E1 to E3, while the data in Comparative Examples 1 to 7 are shown by points C1 to C7, respectively.

From FIG. 9, it can be understood that when the radius ratio Dr/Ds between the rotor core 50 and the stator core 10 is in the range of 0.47 to 0.56, the iron loss is reduced the most. When the radius ratio Dr/Ds is lower than 0.47, the iron loss increases. When the radius ratio Dr/Ds is higher than 0.56, the iron loss also increases.

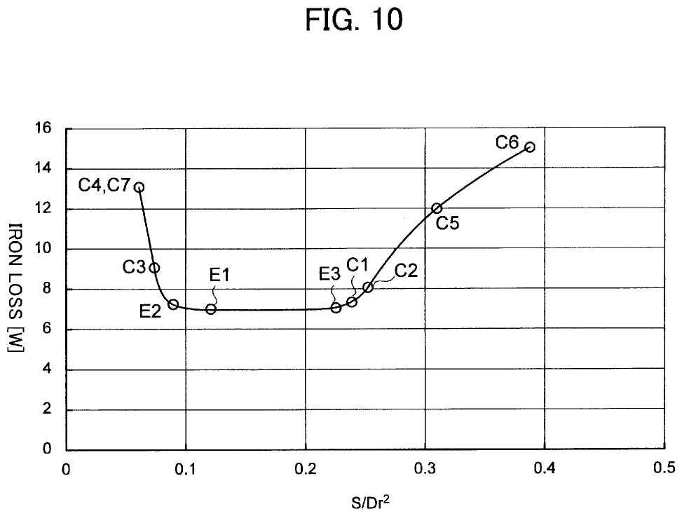

FIG. 10 is a graph showing the relationship between the ratio S/Dr² of the slot area S to the square of the radius Dr, and the iron loss. The horizontal axis indicates the ratio S/Dr² of the slot area S to the square of the radius Dr, while the vertical axis indicates the iron loss W. In FIG. 10, the data in the configuration examples 1 to 3 of the first embodiment are shown by points E1 to E3, while the data in Comparative Examples 1 to 7 are shown by points C1 to C7, respectively.

From FIG. 10, it can be understood that when the ratio S/Dr² of the slot area S to the square of the radius Dr is in the range of 0.089 to 0.224, the iron loss is reduced the most. When the radius ratio Dr/Ds is lower than 0.089, the iron loss increases. When the radius ratio Dr/Ds is higher than 0.224, the iron loss also increases.

In the motor 101 of Comparative Example 1 (FIG. 5(A)), the slot area S is large and the magnetic path surrounding the slot 13 is long, and thus the iron loss is large as shown in FIGS. 9 and 10. Since the radius Dr of the rotor core 50 is as small as 24 mm, the size of the permanent magnet 55 that can be attached to the rotor 5 decreases, and the motor output is reduced.

In the motor 102 of Comparative Example 2 (FIG. 6(A)), the slot area S is large and the magnetic path surrounding the slot 13 is long, and thus the iron loss is large as shown in FIGS. 9 and 10. Since the radius Dr of the rotor core 50 is as small as 24 mm, the motor output is reduced as in Comparative Example 1.

In addition, in Comparative Example 2, since the slot area S is as large as 144.6 mm², the occupancy ratio of the winding 3 decreases. As the occupancy ratio of the winding 3 decreases, the contact area between the winding portions in the slot 13 decreases. This results in reduction in heat dissipation and an increase in the temperature of the winding 3. As the temperature of the winding 3 increases, the winding resistance also increases. This increases copper loss, and reduces the motor efficiency.

In the motor 103 of Comparative Example 3 (FIG. 7(A)), since the radius Dr of the rotor core 50 is large relative to the radius Ds of the stator core 10, the dimension of the stator core 10 in the radial direction is small. Thus, the magnetic resistance increases, and the iron loss increases as shown in FIGS. 9 and 10. Since the slot area S is as small as 79.2 mm², the number of turns of the winding 3 decreases, and the motor output is reduced. If the winding 3 is forcibly housed in the slot 13, the winding 3 may be damaged.

In the motor 104 of Comparative Example 4 (FIG. 8(A)), since the radius Dr of the rotor core 50 is large relative to the radius Ds of the stator core 10, the dimension of the stator core 10 in the radial direction is small. Thus, the magnetic resistance increases, and the iron loss increases as shown in FIGS. 9 and 10. Since the slot area S is as small as 69.9 mm², the motor output is reduced as in Comparative Example 3. Heat tends to accumulate in the slot 13, and thus the heat dissipation is reduced.

Also as for the motors of Comparative Examples 5 to 7, ion loss is large as shown in FIGS. 9 and 10.

In contrast, in the motor 100 of the first embodiment, the radius Dr of the rotor core 50, the radius Ds of the stator core 10, and the slot area S satisfy 0.47≤Dr/Ds≤0.56, and 0.089≤S/Dr²≤0.224. Thus, the iron loss in the stator 1 can be reduced as shown in FIGS. 9 and 10.

Since the radius Dr of the rotor core 50 is in the range of 25 mm to 30 mm, the permanent magnets 55 with a sufficient size can be attached to the rotor core 50, and a reduction in the motor output can be suppressed. Further, since the dimension of the stator core 10 in the radial direction is not extremely small, an increase in the magnetic resistance of the stator core 10 can be suppressed.

Since the slot area S is larger than or equal to 80 mm², a sufficient number of turns of the winding 3 can be secured, and thus the reduction in the motor output can be suppressed. Further, since the slot area S is smaller than or equal to 140 mm², the occupancy ratio of the winding 3 in the slot 13 can be enhanced. Thus, the contact area between the winding portions can be increased, and the heat dissipation can be improved. Thus, an increase in the copper loss due to the temperature increase can be suppressed, and the reduction in the motor output can be suppressed.

Since the winding 3 is wound around the tooth 12 in the bale stacked manner in the slot 13, the contact area between the winding portions is increased, so that heat generated in the winding 3 can be efficiently dissipated to the stator core 10. Thus, an increase in the iron loss due to the temperature increase can be suppressed, and the reduction in the motor output can be suppressed.

Although the sheet thickness of the electromagnetic steel sheet of the stator core 10 is 0.1 to 0.7 mm, and is desirably particularly 0.35 mm. As the thickness of the electromagnetic steel sheet increases, the cost decreases and the strength increases, but iron loss is more likely to occur. When the electromagnetic steel sheet of the stator core 10 has a sheet thickness of 0.35 mm, the iron loss can be reduced without increasing manufacturing costs and reducing its strength.

Meanwhile, the sheet thickness of the electromagnetic steel sheet of the rotor core 50 may be thicker than the sheet thickness of the electromagnetic steel sheet of the stator core 10. This is because of the following reason. In the stator core 10, the magnetic flux flowing from the rotor 5 changes largely due to the rotation of the rotor 5. In contrast, in the rotor core 50, the permanent magnets 55 are fixed thereto, and a change in the magnetic flux in the rotor core 50 due to the rotation of the rotor 5 is small. Thus, the iron loss that occurs in the rotor core 50 is relatively small.

The winding 3 is composed of an aluminum wire, which has higher resistance than a copper wire, but the wire diameter of the winding 3 is 0.7 to 1.2 mm, which is larger than the wire diameter of an ordinary copper wire. Thus, an increase in the winding resistance can be reduced. In particular, since the slot area S is in the range of 80 to 140 mm² as described above, the occupancy ratio of the winding 3 in the slot 13 can be enhanced, and thus the reduction in the motor efficiency can be suppressed.

The permanent magnet 55 of the rotor 5 is composed of a rare earth magnet. A rare earth magnet is easily demagnetized at high temperature. As described above, heat generated in the winding 3 is efficiently dissipated, and an increase in the temperature of the entire motor 100 is suppressed, so that the demagnetization of the permanent magnet 55 at high temperature can be suppressed.

When the number of poles of the rotor 5 is increased, the demagnetization resistance is improved, but the electrical frequency increases and thus the iron loss increases. The motor 100 of the first embodiment has six poles and nine slots, and thus the iron loss can be reduced without decreasing the demagnetization resistance.

### Effects of Embodiment

As described above, in the stator 1 of the first embodiment, the radius Dr of the rotor core 50, the radius Ds of the stator core 10, and the slot area S satisfy:

$$25 mm \leq Dr \leq 30 mm , \\ 0.47 \leq Dr / Ds \leq 0.56 , and \\ 0.089 \leq S / {Dr}^{2} \leq 0.224 .$$

Thus, the iron loss and the copper loss of the stator 1 are reduced, and thus it is possible to suppress the reduction in the motor output.

Further, since the slot area S is smaller than or equal to 140 mm², the occupancy ratio of the winding 3 in the slot 13 can be enhanced, and the heat dissipation can be improved. As a result, it is possible to suppress an increase in the copper loss caused by the increased winding resistance due to the temperature increase. Since the slot area S is larger than or equal to 80 mm², a sufficient number of turns of the winding 3 can be secured, thereby suppressing the reduction in the motor output.

### Second Embodiment

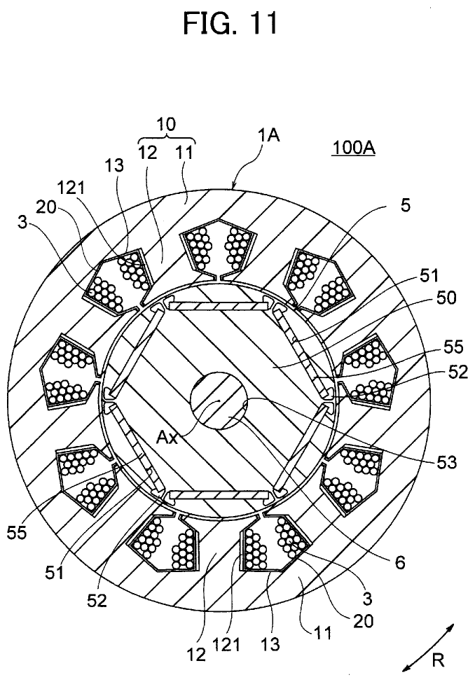

Next, a second embodiment will be described. FIG. 11 is a cross-sectional view illustrating a motor 100A of the second embodiment. The motor 100A of the second embodiment differs from the motor 100 of the first embodiment in that a tooth 12 of a stator 1A has stepped portions 121.

FIG. 12(A) is a cross-sectional view illustrating a part of the stator 1A of the motor 100A. FIG. 12(B) is a cross-sectional view in a plane perpendicular to the tooth center line T of the tooth 12 illustrated in FIG. 12(A).

As illustrated in FIG. 12(B), an end surface of the tooth 12 in the axial direction is referred to as an axial-direction end surface 12e. The stepped portions 121 are formed on both sides of the axial-direction end surface 12e of the tooth 12 in the circumferential direction (i.e., on both sides of the tooth 12 in the width direction). Each stepped portion 121 is formed at the corner where the axial-direction end surface 12e and the side surface 12b of the tooth 12 intersect each other.

Insulators 25 are fixed to the axial-direction end surfaces 12e of the tooth 12. Each insulator 25 is a resin molded body and fixed to cover the axial-direction end surface 12e of the tooth 12.

Each insulator 25 has engagement portions 25a on both sides thereof in the circumferential direction, i.e., on both sides in the width direction of the tooth 12. The engagement portions 25a engage with the stepped portions 121 of the stator 1A. The insulator 25 is fixed to the tooth 12 through the engagement between the engagement portion 25a and the stepped portion 121.

The insulator 25 has curved surfaces 25b on both sides thereof in the circumferential direction, so as not to damage the winding 3 wound on the insulator 25. Thus, the damage to the winding 3 wound on the insulator 25 can be suppressed.

As illustrated in FIG. 12(A), the insulating film 20 described in the first embodiment is fixed to the side surface 12b of the tooth 12. The insulating film 20 covers the inner circumference 11a of the core back 11, the inclined surface 12c and the end surface 12d of the tooth 12, as well as the side surface 12b of the tooth 12.

The winding 3 is wound around the tooth 12 via the insulating films 20 and the insulators 25. The insulating film 20 is thin, and thus it is easy to wind the winding 3 around the tooth 12. Thus, the occupancy ratio of the winding 3 in the slot 13 can be enhanced, so that the heat dissipation can be improved, and the copper loss can be suppressed.

The insulator 25 is made of PBT. PBT has a higher thermal conductivity than liquid crystal polymer (LCP), which is commonly used for insulators. Thus, heat generated in the winding 3 is easily transferred to the stator core 10 via the insulator 25. Thus, an increase in the winding resistance due to the temperature increase can be suppressed, and the reduction in the motor efficiency can be suppressed.

FIG. 13 is a schematic diagram illustrating one configuration example of the insulator 25. The insulator 25 may have grooves 25c each of which serves as a holder and holds an end of the insulating film 20 in the axial direction.

With this configuration, the insulating film 20 can be held by the groove 25c of the insulator 25, and thus the insulating film 20 can be easily fixed to the stator core 10.

A hollow portion 25d may be formed inside the insulator 25. By forming the hollow portion 25d, the surface area for heat dissipation is increased to improve heat dissipation, and the weight of the insulator 25 is also reduced. The forming position of the hollow portion 25d in the insulator 25 is not limited.

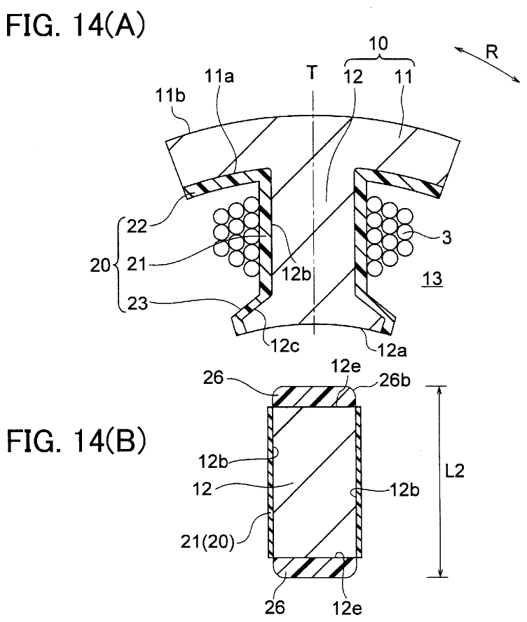

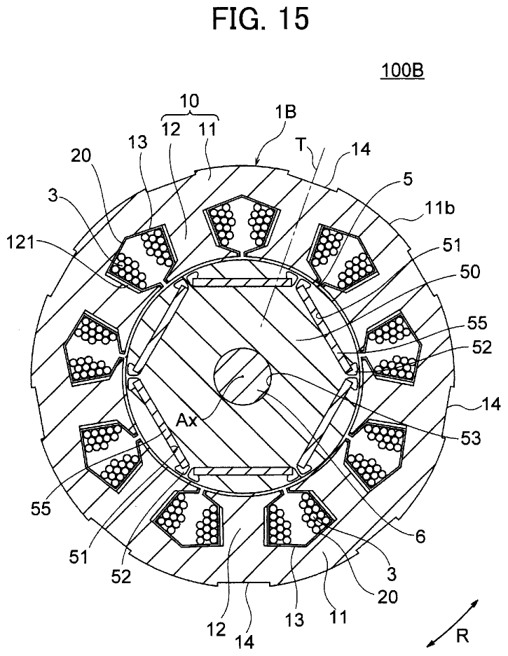

FIG. 14(A) is a cross-sectional view illustrating a part of a stator of a motor of Comparative Example. FIG. 14(B) is a cross-sectional view in a plane perpendicular to the tooth center line T of the tooth 12 illustrated in FIG. 14(A).

In Comparative Example illustrated in FIGS. 14(A) and 14(B), no stepped portion is provided at the axial-direction end surface 12e of the tooth 12. An insulator 26 is fixed to the axial-direction end surface 12e of the tooth 12.

The insulator 26 has curved surfaces 26b on both sides thereof in the circumferential direction so as not to damage the winding 3 wound on the insulator 26. For this reason, the insulator 26 needs to have a sufficient height in the axial direction so as to form the curved surfaces 26b. As a result, as shown in FIG. 14(B), a combined dimension L2 in the axial direction of the tooth 12 and the insulators 26 located on both sides of the tooth 12 in the axial direction is lengthened.

In contrast, in the second embodiment, the tooth 12 has the stepped portions 121 at each axial-direction end surface 12e. Each insulator 25 has the engagement portions 25a that engage with the stepped portions 121. Thus, the curved surface 25b can be formed on the insulator 25, even when the height of the insulator 25 in the axial direction is low. As a result, as shown in FIG. 12(B), a combined dimension L1 in the axial direction of the tooth 12 and the insulators 25 located on both sides of the tooth 12 in the axial direction can be shortened.

As above, by shortening the combined dimension L1 of the tooth 12 and the insulators 25, the circumferential length of the winding 3 can be shortened. By shortening the circumferential length of the winding 3, the winding resistance can be reduced, and the copper loss can be reduced.

In this regard, the magnetic path is made narrower by the formation of the stepped portions 121 at both ends of the tooth 12 in the axial direction, which may increase the iron loss due to magnetic saturation. However, as described in the first embodiment, the radius Dr of the rotor core 50, the radius Ds of the stator core 10, and the slot area S are set to satisfy:

$$25 mm \leq Dr \leq 30 mm , \\ 0.47 \leq Dr / Ds \leq 0.56 , and \\ 0.089 \leq S / {Dr}^{2} \leq 0.224 .$$

Thus, an increase in the iron loss in the stator 1A can be suppressed, and the reduction in the motor efficiency can be suppressed.

The stepped portion 121 is formed on the side surface 12b side of the tooth 12 in this example, but the stepped portion 121 may be formed on the inner circumference 11a side of the core back 11. Alternatively, the stepped portion may be formed on the inclined surface 12c side or the end surface 12d side of the tooth 12. In other words, the stepped portion may be formed at a portion of the axial-direction end surface of the stator core 10 facing the slot 13.

In addition, the insulator 25 is fixed at each of both ends of the tooth 12 in the axial direction in this example, but the insulator 25 may be fixed only at one end of the tooth 12 in the axial direction.

Except for the above-described points, the motor 100A of the second embodiment is configured in the same manner as the motor 100 of the first embodiment.

As described above, in the second embodiment, the insulating films 20 are fixed to the side surfaces 12b of the tooth 12, and the insulators 25 are fixed to the axial-direction end surfaces 12e. Thus, the winding 3 can be wound around the tooth 12 via the insulating films 20 and the insulators 25.

The stepped portion 121 is formed at a portion of the axial-direction end surface of the stator core 10 facing the slot 13, and the insulator 25 has the engagement portion 25a that engages with the stepped portion 121. Thus, the insulator 25 can be easily fixed to the tooth 12. In addition, the combined dimension of the insulators 25 and the tooth 12 in the axial direction can be shortened, and thus the circumferential length of the winding 3 can be reduced and the copper loss can be reduced.

Since the insulator 25 has the grooves 25c each of which serves as the holder and holds the insulating film 20. Thus, the insulating film 20 can be easily fixed to the stator core 10.

### Third Embodiment

Next, a third embodiment will be described. FIG. 15 is a cross-sectional view illustrating a motor 100B of the third embodiment. The motor 100B of the third embodiment differs from the motor 100A of the second embodiment in that grooves 14 are formed at an outer circumference 11b of a core back 11 of a stator 1B.

The grooves 14 formed at the outer circumference 11b of the core back 11 extend in the axial direction over the entire length of the stator core 10. Therefore, when the motor 100B is mounted in the compressor 300 (FIG. 17), a flow path through which refrigerant flows in the axial direction is formed between the hermetic container 301 of the compressor 300 (FIG. 17) and the groove 14.

Portions of the winding 3 disposed on the inner side in the radial direction (on the side closer to the rotor 5) in the slot 13 are more likely to be cooled by the refrigerant flowing through a gap between the stator 1B and the rotor 5. In contrast, the other portions of the winding 3 disposed on the outer side in the radial direction (on the side closer to the core back 11) in the slot 13 are less likely to be cooled.

In the third embodiment, the refrigerant flows through the grooves 14 at the outer circumference 11b of the core back 11, and thus it is possible to dissipate heat generated in the winding 3 disposed on the outer side in the radial direction in the slot 13. Thus, an increase in the temperature of the winding 3 can be suppressed.

The groove 14 in the core back 11 is desirably formed on a straight line in the radial direction that passes through the circumferential center of the tooth 12, i.e., on the tooth center line T. Since the groove 14 is arranged as above, the groove 14 interrupts as least as possible the magnetic flux in the stator core 10, and thus an increase in the iron loss can be suppressed.

Except for the above-described points, the motor 100B of the third embodiment is configured in the same manner as the motor 100A of the second embodiment.

As described above, in the third embodiment, since the grooves 14 are formed at the outer circumference 11b of the core back 11 of the stator 1B, the heat dissipation of the winding 3 can be improved. Thus, an increase in the temperature of the winding 3 can be suppressed, and the reduction in the motor efficiency can be suppressed.

Incidentally, grooves which are the same as the grooves 14 of the third embodiment may be formed at the outer circumference 11b (FIG. 1) of the core back 11 of the stator 1 of the first embodiment.

### Modification

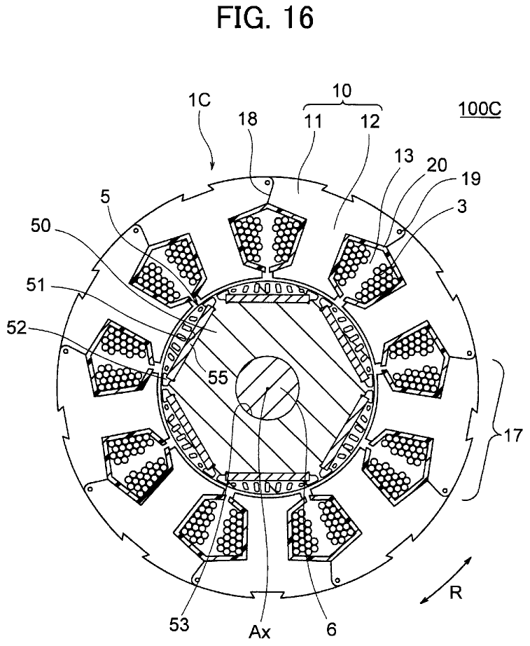

Next, modifications of the first to third embodiments will be described. FIG. 16 is a cross-sectional view illustrating a motor 100C of the modification. In the motor 100C of the modification, a stator core 10 of a stator 1C is formed of a plurality of split cores 17 connected in an annular shape. The stator core 10 is formed of nine split cores 17 in this example, but the number of split cores 17 only needs to be two or more.

Each of the split cores 17 has one tooth 12. A split surface 18 is formed between adjacent split cores 17. The adjacent split cores 17 are connected to each other by a crimping portion 19 or thin-walled portion formed on the outer circumferential side of the split surface 18. The split cores 17 may be formed as parts independent from each other and welded together at the split surfaces 18.

The insulating film 20 described in the first embodiment is fixed to an inner surface of the slot 13 of the split core 17. The insulator 25 (FIG. 12(B)) described in the second embodiment may be fixed to the axial-direction end surface of the split core 17.

The stepped portion 121 (FIG. 12(A)) described in the second embodiment may be formed at a portion of the axial-direction end surface of the split core 17 facing the slot 13.

At a time of assembling the stator 1C, the insulating films 20 and the insulators 25 are fixed to the split cores 17 in a state where the stator core 10 having the split cores 17 connected together are linearly extended. Then, the winding 3 is wound around the tooth 12 of the split core 17 via the insulating films 20 and the insulators 25. Thereafter, the stator core 10 is assembled to have an annular shape, and an annular stator core 10 is obtained.

This modification enables the fixing of the insulating films 20 and the insulators 25 and the winding of the winding 3 in a state where the split cores 17 are linearly extended. Thus, the insulating films 20 and the insulators 25 can be easily fixed, and the winding 3 can be easily wound in the bale stacked manner. Thus, the occupancy ratio of the winding 3 can be enhanced, and the heat dissipation can be further improved.

### (Compressor)

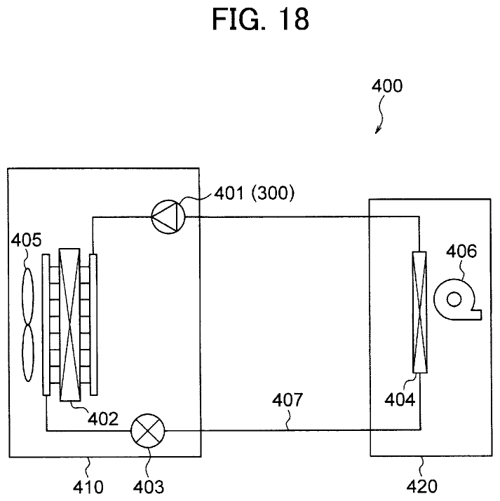

FIG. 17 is a longitudinal-sectional view illustrating the compressor 300 to which the motor of each embodiment and modification is applicable. The compressor 300 is a rotary compressor and is used, for example, in a refrigeration cycle apparatus 400 (FIG. 18).

The compressor 300 includes a compression mechanism 310, the motor 100 that drives the compression mechanism 310, the shaft 6 that connects the compression mechanism 310 and the motor 100, and the hermetic container 301 that houses these components. In this example, the axial direction of the shaft 6 is the vertical direction, and the motor 100 is disposed above the compression mechanism 310.

The hermetic container 301 is a container formed of a steel plate. The stator 1 of the motor 100 is incorporated inside the hermetic container 301 by shrink-fitting, press-fitting, welding, or the like. A discharge pipe 307 through which the refrigerant is discharged to the outside and terminals 305 for supplying electric power to the motor 100 are provided on an upper part of the hermetic container 301. An accumulator 302 that stores a refrigerant gas is attached to the outside of the hermetic container 301. At the bottom of the hermetic container 301, a refrigerant oil is stored to lubricate bearings of the compression mechanism 310.

The compression mechanism 310 includes a cylinder portion 311 having a cylinder chamber 312, a rolling piston 314 fixed to the shaft 6, a vane dividing the inside of the cylinder chamber 312 into a suction side and a compression side, and an upper frame 316 and a lower frame 317 which close both ends of the cylinder chamber 312 in the axial direction.

Both the upper frame 316 and the lower frame 317 have bearings rotatably supporting the shaft 6. An upper discharge muffler 318 and a lower discharge muffler 319 are mounted onto the upper frame 316 and the lower frame 317, respectively.

The cylinder portion 311 includes the cylinder chamber 312 having a cylindrical shape about the axis Ax. An eccentric shaft portion 61 of the shaft 6 is located inside the cylinder chamber 312. The eccentric shaft portion 61 has an eccentric center with respect to the axis Ax. The rolling piston 314 is fitted to the outer circumference of the eccentric shaft portion 61. When the motor 100 rotates, the rolling piston 314 eccentrically rotates in the cylinder chamber 312.

The cylinder portion 311 is provided with a suction port 313 through which the refrigerant gas is sucked into the cylinder portion 311. A suction pipe 303 is attached to the hermetic container 301 so as to communicate with the suction port 313. Through the suction pipe 303, the refrigerant gas is supplied from the accumulator 302 to the cylinder chamber 312.

The stroke volume of the compression mechanism 310, i.e., the capacity of the cylinder portion 311, is 6 to 18 cc.

To the compressor 300, a mixture of a low-pressure refrigerant gas and a liquid refrigerant is supplied from a refrigerant circuit of the refrigeration cycle apparatus 400 (FIG. 18). If the liquid refrigerant flows into and is compressed by the compression mechanism 310, this may cause the failure of the compression mechanism 310. For this reason, the accumulator 302 separates the refrigerant into the liquid refrigerant and the refrigerant gas and supplies only the refrigerant gas to the compression mechanism 310.

The terminals 305 of the compressor 300 are connected to wires from the inverter 7 that controls the driving of the motor 100. The motor 100 is controlled with PWM (Pulse Width Modulation) by the inverter 7.

The operation of the compressor 300 is as follows. When current is supplied from the inverter 7 to the windings 3 of the stator 1 through the terminals 305, the rotor 5 rotates due to the action of the rotating magnetic field generated by the current and the magnetic field of the permanent magnets 55 of the rotor 5.

The low-pressure refrigerant gas is sucked from the accumulator 302 into the cylinder chamber 312 of the compression mechanism 310 through the suction port 313. The eccentric shaft portion 61 of the shaft 6 and the rolling piston 314 attached to the eccentric shaft portion 61 eccentrically rotate inside the cylinder chamber 312 to compress the refrigerant in the cylinder chamber 312.

The refrigerant compressed in the cylinder chamber 312 is discharged into the hermetic container 301 through a discharge port (not shown) and the discharge mufflers 318 and 319. The refrigerant discharged into the hermetic container 301 rises inside the hermetic container 301 through holes and the like in the motor 100, is discharged through the discharge pipe 307, and is then sent out to the refrigerant circuit of the refrigeration cycle apparatus 400 (FIG. 18).

The motor of each embodiment and modification has high motor efficiency since the iron loss and copper loss are suppressed. Thus, by using the motor as a driving source of the compressor 300, the operating efficiency of the compressor 300 can be improved.

When the number of revolutions of the motor 100 is set at a constant value, the torque of the motor 100 decreases as the stroke volume of the compression mechanism 310 is increased. As described in the first embodiment, the motor 100 in which the radius Dr of the rotor core 50, the radius Ds of the stator core 10, and the slot area S satisfy 25 mm≤Dr≤30 mm, 0.47≤Dr/Ds≤0.56, and 0.089≤S/Dr²≤0.224 is used. By using such a motor 100, the iron loss and copper loss can be reduced when the stroke volume is in the range of 6 to 18 cc.

Since the motor 100 is controlled to be driven by the inverter 7, fluctuations of the load on the motor 100 can be suppressed. Thus, a safety operation of the compressor 300 can be achieved.

### (Refrigeration Cycle Apparatus)

Next, the refrigeration cycle apparatus 400 to which the compressor 300 of FIG. 17 is applicable will be described. FIG. 18 is a diagram illustrating the refrigeration cycle apparatus 400. The refrigeration cycle apparatus 400 is, for example, an air conditioner, and includes a compressor 401, a condenser 402, a throttle device (decompression device) 403, and an evaporator 404. The compressor 401, the condenser 402, the throttle device 403, and the evaporator 404 are coupled together by a refrigerant pipe 407 to constitute a refrigeration cycle. The refrigerant circulates through the compressor 401, the condenser 402, the throttle device 403, and the evaporator 404 in this order.

The compressor 401, the condenser 402, and the throttle device 403 are provided in an outdoor unit 410. The compressor 401 is constituted by the compressor 300 described with reference to FIG. 20. The outdoor unit 410 is provided with an outdoor fan 405 that blows air to the condenser 402. The evaporator 404 is provided in an indoor unit 420. The indoor unit 420 is provided with an indoor fan 406 that blows air to the evaporator 404.

The operation of the refrigeration cycle apparatus 400 is as follows. The compressor 401 compresses sucked refrigerant and sends the compressed refrigerant. The condenser 402 exchanges heat between the refrigerant flowing therein from the compressor 401 and the outdoor air to condense and liquefy the refrigerant and sends the liquefied refrigerant to the refrigerant pipe 407. The outdoor fan 405 supplies the outdoor air to the condenser 402. The throttle device 403 adjusts the pressure of the refrigerant flowing through the refrigerant pipe 407.

The evaporator 404 exchanges heat between the refrigerant brought into a low-pressure state by the throttle device 403 and the indoor air. The refrigerant evaporates by taking heat from the air and is sent to the refrigerant pipe 407. The indoor fan 406 supplies the air from which heat is taken in the evaporator 404, into the interior of a room.

The motor of each embodiment and modification has high motor efficiency since the iron loss and copper loss are suppressed. Thus, by using this motor in the compressor 401 of the refrigeration cycle apparatus 400, the operating efficiency of the refrigeration cycle apparatus 400 can be improved.

The features of each embodiment and each modification described above can be combined as appropriate.

1. A motor comprising:
a rotor comprising a rotor core having an annular shape about an axis, and a permanent magnet attached to the rotor core; and
a stator comprising a stator core having a core back surrounding the rotor from outside in a radial direction about the axis, a tooth extending toward the rotor from the core back, and a slot adjacent to the tooth in a circumferential direction about the axis, an insulating portion fixed to the tooth, and a winding wound around the tooth via the insulating portion and having a conductive body made of aluminum,
wherein a radius Dr of the rotor core, a radius Ds of the stator core, and an area S of the slot satisfy:
$$25 mm \leq Dr \leq 30 mm , \\ 0.47 \leq Dr / Ds \leq 0.56 , and \\ 0.089 \leq S / Dr 2 \leq 0.224 .$$

2. The motor according to claim 1, wherein the area S of the slot is 80 mm² or more and 140 mm² or less.

3. The motor according to claim 1, wherein the insulating portion has an insulator disposed at an end surface of the tooth in a direction of the axis.

4. The motor according to claim 3,
wherein a stepped portion is formed at a portion of the end surface of the stator core in the direction of the axis so as to face the slot, and
wherein the insulator has an engagement portion engaging with the stepped portion.

5. The motor according to claim 3,
wherein the insulating portion has an insulating film disposed at an end surface of the tooth in the circumferential direction, and
wherein the insulator has a holder holding the insulating film.

6. The motor according to claim 3, wherein the insulator is made of polybutylene terephthalate.

7. The motor according to claim 1, wherein the winding has a wire diameter of 0.7 mm or more and 1.2 mm or less.

8. The motor according to claim 1, wherein the winding is wound around the tooth in a bale stacked manner.

9. The motor according to claim 1,
wherein the rotor has six magnetic poles, and
wherein the stator has nine slots.

10. The motor according to claim 1,
wherein the stator core is formed of a stacked body of electromagnetic steel sheets, and
wherein the electromagnetic steel sheet has a sheet thickness of 0.35 mm.

11. The motor according to claim 1,
wherein a groove extending in a direction of the axis is formed at an outer circumference of the stator, and
wherein the groove is located on a straight line in the radial direction that passes through a center of the tooth.

12. The motor according to claim 1, wherein the permanent magnet of the rotor is formed of a rare earth magnet.

13. The motor according to claim 1, wherein the motor is controlled by an inverter.

14. A compressor comprising:
the motor according to claim 1; and
a compression mechanism driven by the motor.

15. The compressor according to claim 14,
wherein the compression mechanism has a cylinder portion, and
wherein the cylinder portion has a capacity of 6 cc to 18 cc.

16. A refrigeration cycle apparatus comprising the compressor according to claim 14, a condenser, a decompression device, and an evaporator.

17. The motor according to claim 3, wherein a hollow portion is formed in the insulator.

18. The motor according to claim 1, wherein an inner circumferential surface of the core back extends from a root portion of the tooth linearly at an angle of 90 degrees relative a side surface of the tooth.
